(19) United States
(12) Patent Application Publication
(10) Pub. No.: US 2004/0021069 A1
(43) Pub. Date: Feb. 5, 2004

(54) Spectroscopic analyser for surface analysis, and method therefor

(75) Inventor: Bryan Robert Barnard, East Sussex (GB)

Correspondence Address: Nathan M. Rau, Westman, Champlin & Kelly, Suite 1600, 900 Second Avenue South, Minneapolis, MN, 55402-3319, US

(73) Assignee: Thermo Electron Corporation, Waltham, MA

(21) Appl. No.: 10/421,676

(22) Filed: Apr. 23, 2003

(30) Foreign Application Priority Data
Apr. 23, 2002 (GB) 0209255.9

(51) Int. Cl. H01J 49/00; B01D 59/44

(52) U.S. Cl. 250/288

(57) ABSTRACT

A spectroscopic analyser and method of use, for surface analysis spectroscopy, are disclosed. The spectroscopic analyser 10 has a time-of-flight (TOF) spectrometer which analyses secondary electrons emitted from a surface of a sample 30 on excitation by an irradiation source 40. The TOF spectrometer includes a gate 50, which receives and selectively passes a proportion of the secondary electrons by pulsed deflection or retardation of the electron beam using gating members 55. In that manner one or more pulses of electrons enter a magnetic field-free flight tube 90 and reach a detector 120 downstream of the gate 50. The flight times, and therefore energies, of the detected electrons through the flight tube 90 are thereby detected. A curved electron mirror 100 may be used to increase the flight path of the pulsed electrons in the flight tube 90, thereby increasing the spread of each electron pulse within the analyser 10.

### FIELD OF THE INVENTION

The present invention relates to a spectroscopic analyser for surface analysis, and to a method for surface analysis spectroscopy. The invention relates particularly (but not exclusively) to the determination of energy of electrons emitted from the surface of a material during X-ray photoelectron or Auger electron spectroscopy.

### BACKGROUND OF THE INVENTION

In the field of surface analysis, the chemical composition and properties of the top few atomic layers of a material to be analysed are of interest. These parameters are determined by measuring the characteristic energy distribution of electrons emitted from the surface of a sample of the material under investigation. The surface is irradiated by a suitable exciting beam and emitted electrons are collected into an electron spectrometer, in which their energies are determined.

Two well-known techniques for carrying out such analysis are X-ray photoelectron spectroscopy (XPS) and Auger electron spectroscopy (AES). In XPS, the sample is irradiated with X-rays, causing the ejection of inner-shell electrons. The binding energies of these photoelectrons, as measured by the spectrometric energy analyser, are characteristic of the elements present in the surface and may also provide information about the bonding states of the elements thereby detected. In AES, a focused beam of primary electrons irradiates the sample surface, causing the emission of core electrons from atoms contained on the surface of the sample. The core holes arising from this are filled again by relaxation of the atoms, in which electrons with lower binding energies drop down into the holes. The energy released by these de-excitation processes results in the emission of X-rays or Auger electrons. The energies of these Auger electrons are, again, characteristic of the elements from which they derive and can thus be used to identify the elements present in the surface of the sample.

A wide variety of energy analysers has been used to perform such surface analysis measurements, but the preferred techniques involve the use of either a toroidal electrostatic analyser or an electrostatic cylindrical mirror analyses. These analysers provide measurements of high energy resolution, but are limited in the range of energies which can be analysed in a single measurement. This range is typically less than 50 eV, while the full energy range of the emitted electrons may be from 50 eV to 2500 eV. Therefore, in order to perform an analysis of the whole range of energies of interest, the analyser must scan through this range, by sweeping the voltages applied to the electrostatic deflection plates, under computer control. Clearly, this procedure is inefficient, since, at any time during electron detection, the majority of the electrons being emitted from the sample are outside the range of energies under analysis and are therefore not detected.

Ideally, electrons over the whole range of applicable energies would be detected simultaneously by the analyser. Recently, several analysers which are capable of detecting a wide range of energies have been proposed. WO 99/35668 discloses an electron energy analyser, using a hyperbolic electrostatic field to deflect the electrons onto a detector. U.S. Pat. No. 5,969,354 relates to an electron analyser, in which a solenoid sets up an axial magnetic field in a drift region of the analyser. The electrons gyrate around the magnetic field lines and the amount of rotation of the electrons exiting the region depends on their energies. Both analysers record the position of the electrons on detector plates, in order to obtain a measurement of energy. While these analysers provide good energy resolution, they do suffer from a number of limitations, such as providing poor access to the sample, being able to accommodate only a limited sample size, and requiring complicated detection electronics.

It is increasingly desirable to expose a sample to as low a dose of irradiation by photons or electrons as possible, in order to minimise sample damage and reduce the analysis area on the sample. For this to be practical, there must correspondingly be as high a detection efficiency as possible for the electrons, so as to keep the overall acquisition time as short as possible.

In XPS and AES, excited electrons are emitted from the sample in all directions. It is, therefore, also desirable to collect the electrons over as large a solid angle as possible. A high collection efficiency is usually accomplished using an electron lens to focus a diverging beam of electrons from the sample into the analyser. Electrostatic lenses and magnetic lenses have been used for this purpose, but both types of lens are unable to focus electrons having widely ranging energies, so are unsuitable for use in an analyser for the desired application. Without the use of an electron lens, the acceptance angle of a conventional analyser would be very small, typically less than 1°.

Strong permanent magnets located behind the sample, known as magnetic immersion lenses, have been used to constrain the trajectories of the emitted electrons. A magnetic field gradient, such as that used in “Apparatus for positron annihilation-induced Auger electron spectroscopy” by Chun et al. (Review of Scientific Instruments, vol. 60, no. 12, December 1989), reduces the angular spread of the emitted electrons and redirects them along the spectrometer axis. However, because of the strong magnetic field required at the sample, such an analyser is not suitable for electron beam Auger analysis.

It is an object of the present invention to provide an improved analyser for electron spectroscopy, particularly for use in surface analysis.

### SUMMARY OF THE INVENTION

According to a first aspect of the present invention, there is provided a spectroscopic analyser comprising: means for irradiating a surface of a material to be analysed; and a time of flight (ToF) spectrometer including: gating means at an entrance to the TOF spectrometer, the gating means being arranged to receive and selectively pass at least a part of a beam of electrons emitted from the surface of the material to be analysed, as one or more pulses of emitted electrons; a flight tube along which the or each pulse of emitted electrons is arranged to pass; and a detector arrangement downstream of the gating means and being arranged to detect the arrival of electrons within the or each pulse from the gating means via the flight tube, and to permit determination of the times of flight of the detected electrons through the flight tube.

The spectroscopic analyser of the present invention provides a number of advantages over prior art analysers. The use of a time-of-flight energy spectrometer permits simultaneous detection of electrons having a wide range of energies (not least because the arrangement requires no input lens), and is operable over a wide solid angle. Nevertheless, high energy resolution is still possible. The overall detection efficiency is high which means that low doses of irradiation can be employed and the overall acquisition time at the detector can be kept short.

The arrangement of the present invention also allows for ready access to a sample of material to be analysed without limiting its size.

The invention is particularly suitable for X-ray photoelectron spectroscopy and Auger electron spectroscopy. In the former, the surface of the material to be analysed is irradiated with X-rays which cause secondary electrons to be emitted and these are gated into the time-of-flight spectrometer in pulses. In the latter arrangement, primary electrons bombard the surface of the material to be analysed and, again, secondary electrons are emitted which are gated into the time-of-flight spectrometer.

Time-of-flight spectrometers are well known in the field of mass spectrometry, where it is desirable to determine the mass-to-charge ratio of ions or molecules. In such time-of-flight spectrometers, however, it is usual to accelerate the particles whose mass-to-charge ratio is to be determined using an electrostatic field. In that case, the energy which the particles have within the time-of-flight mass spectrometer, ½mv², is equated to the energy gained by the particles in the electrostatic field, qV, where V is electrical potential and q is the charge on the ion. Assuming no acceleration within the flight tube of the time-of-flight mass spectrometer, so that the velocity of the ions therein is inversely proportional to the time-of-flight, it may be shown that the time-of-flight is proportional to the square root of the mass-to-charge ratio.

By contrast, the time-of-flight spectrometer in the present invention does not measure mass-to-charge ratios, as it is instead the energy of the particles emitted from the surface of the sample to be analysed that is of interest. Thus, no acceleration potential is needed between the surface of the sample and the inlet to the flight tube of the TOF spectrometer. In that case, it may be shown that the time-of-flight of the particles emitted from the surface of the material to be analysed is proportional to E^{-1/2} for particles of a given mass. For X-ray photoelectron spectroscopy and Auger electron spectroscopy, the mass is simply the mass of an electron in each case so the electrons separate in time-of-flight in accordance with their energies. A pulse of electrons gated into the time-of-flight spectrometer will accordingly spread out over the length of the flight tube with the more energetic electrons arriving before the less energetic electrons.

In a preferred embodiment, the spectroscopic analyser further comprises a mirror mounted within the flight tube of the TOF spectrometer and arranged to reflect electrons within the pulse of emitted electrons so that the electrons traverse at least a part of the length of the flight tube in generally opposing directions. Employing a mirror allows the effective path length traversed by the electrons within the flight tube to be increased for a given length of flight tube.

Most preferably, the mirror is generally spherical in shape, since this permits a wide range of electron energies to be refocused to the detector. However, a toroidal or elliptical mirror may be employed as an alternative. In view of the foregoing explanation of the purpose of the time-of-flight spectrometer, it will be appreciated that, contrary to time-of-flight mass spectrometers, it is unnecessary to perform energy compensation as in a traditional ion beam time-of-flight reflectron.

The mirror of preferred embodiments of the present invention may be of magnetic or electrostatic design. In a particularly preferred embodiment, the mirror comprises first and second transparent concentric meshes spaced along a longitudinal axis of the flight tube. In that case, preferably, the first mesh is maintained in use at a first, ground potential, and the second mesh is maintained in use at a second voltage which is greater than the maximum energy of interest of the electrons in the flight tube.

Although an important benefit of the arrangement of the present invention is that no deceleration or retardation of the emitted electrons is necessary between the surface of the sample to be analysed and the time-of-flight spectrometer, it is nevertheless envisaged that, where data of higher resolution over a narrower range of energies is required, the electrons may be retarded before entry into the flight tube to a much lower energy. This may be accomplished, for example, by the use of a retarding mesh or lens between the surface of the material to be analysed and the gating means.

In preferred embodiments, the gating means opens and closes to the passage of the beam of emitted electrons under the control of an applied voltage or current. Most simply, this may be achieved using a retarding voltage which is greater than the maximum electron energy. Most favourably, however, gating is achieved by the deflection of the emitted electrons from their normal flight path into a trajectory where they can no longer reach the detector. This may be achieved by a magnetic or electrostatic deflection.

In a particularly preferred embodiment of the present invention, the gating means comprises a plurality of gating members disposed across the entrance to the flight tube, and defining therebetween a plurality of entrance channels for the emitted electrons. Then, the spectroscopic analyser may further comprise means for generating voltages of opposing polarity, a first output thereof, of a first polarity, being connected in use to even ones of the plurality of gating members, and a second output thereof, of a second polarity, being connected in use to odd ones of the plurality of gating members. When no voltages are applied, the beam of emitted electrons may pass through the channels defined between the gating members, which are preferably plates, without obstruction. When alternate plates are connected to drive voltages of opposite polarity, however, the beam of emitted electrons is deflected away from the trajectory of the unobstructed beam. The electrons deflected by the gating members in this way may be directed towards baffles (not shown), which are specifically located downstream of the gating means to intercept the electrons. Alternatively, the deflected electrons may be intercepted by colliding with the gating members themselves, or with the walls of the flight tube. The interception of the electrons may occur either upstream or downstream of the electron mirror, depending on the voltages applied to the gating members. On arrival at these sites, the electrons are either absorbed, or scattered, producing low energy electrons which contribute to a background count rate in the spectrum detected at the detector. It is possible to eliminate the count rate of the very low energy electrons arriving at the detector by applying a small negative bias at the front of the detector.

In an alternative embodiment of the present invention, odd ones of the plurality of gating members are connected in use to a ground potential and even ones of the plurality of gating members are connected in use to the first or second output of the means for generating voltages. This allows for simplification of the electronics.

With such arrangements, pulses may be generated of one nanosecond or less duration. In its simplest form, the gating means is used to generate a plurality of discrete, signal pulses, with a typical repetition period of perhaps 100 nanoseconds. In a more advantageous embodiment, however, a pulse sequence is applied to the gate by appropriate application of drive voltages to the gating members, for example. A particularly preferred pulse sequence is a Hadamard sequence which is reconstructed at the detector as a Hadamard transform. Thus, in this embodiment, the gating means generates a series of discrete pulse trains rather than a series of discrete single pulses.

The detector may comprise, for example, one or more micro channel plates (MCPs) and, optionally, a time to digital convertor (TDC). The TDC is preferably a histogramming TDC and the histograms stored in the TDC may be forwarded to a central processor (for example, within a personal computer) for further analysis.

Preferably, the TDC and gating means are synchronised by a central controller.

In accordance with a second aspect of the present invention, there is provided a method of surface analysis spectroscopy comprising irradiating a surface of a material to be analysed, so as to cause emission of electrons therefrom; gating at least a part of the emitted electrons into a flight tube of a time-of-flight spectrometer so as to provide a pulse of electrons therein; and measuring the time-of-flight of these electrons in the pulse as they pass between the gate and pulse detector.

Advantageous features of this method are set out in the dependent claims.

### BRIEF DESCRIPTION OF THE DRAWINGS

An embodiment of the present invention will now be described by way of example only and with reference to the accompanying drawings in which:

FIG. 1 shows a schematic arrangement of a spectroscopic analyser embodying the present invention;

FIG. 2 shows a schematic representation of a preferred electron gate for the spectroscopic analyser of FIG. 1; and

FIG. 3 shows a preferred arrangement for an electron mirror, again for use in the spectroscopic analyser of FIG. 1.

### DETAILED DESCRIPTION OF PREFERRED EMBODIMENTS

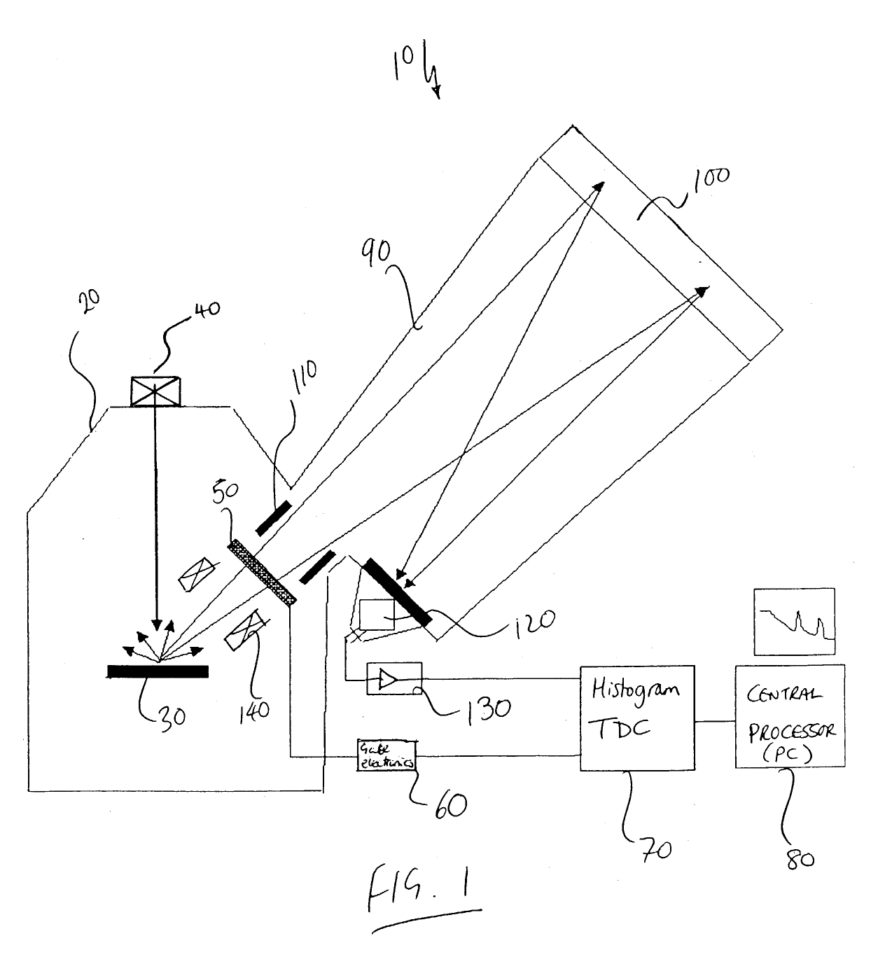

Referring first to FIG. 1, a spectroscopic analyser 10 is shown in schematic detail. The analyser 10 is contained within a vacuum chamber 20 and a sample 30 of a material to be analysed is mounted within a sample holder (not shown) in the vacuum chamber 20.

An irradiation source 40 is mounted onto the vacuum chamber 20 for irradiation of the sample 30. The spectroscopic analyser 10 of FIG. 1 is configured in particular to allow either X-ray photoelectron spectroscopy or Auger electron spectroscopy. In the former case, the irradiation source 40 generates a beam of X-rays which are directed on to the surface of the sample 30. In the latter case, a beam of electrons is instead directed at the surface of the sample 30.

In either case, the incident radiation generates secondary electrons as described previously. The secondary electrons are emitted from the sample 30 in all directions.

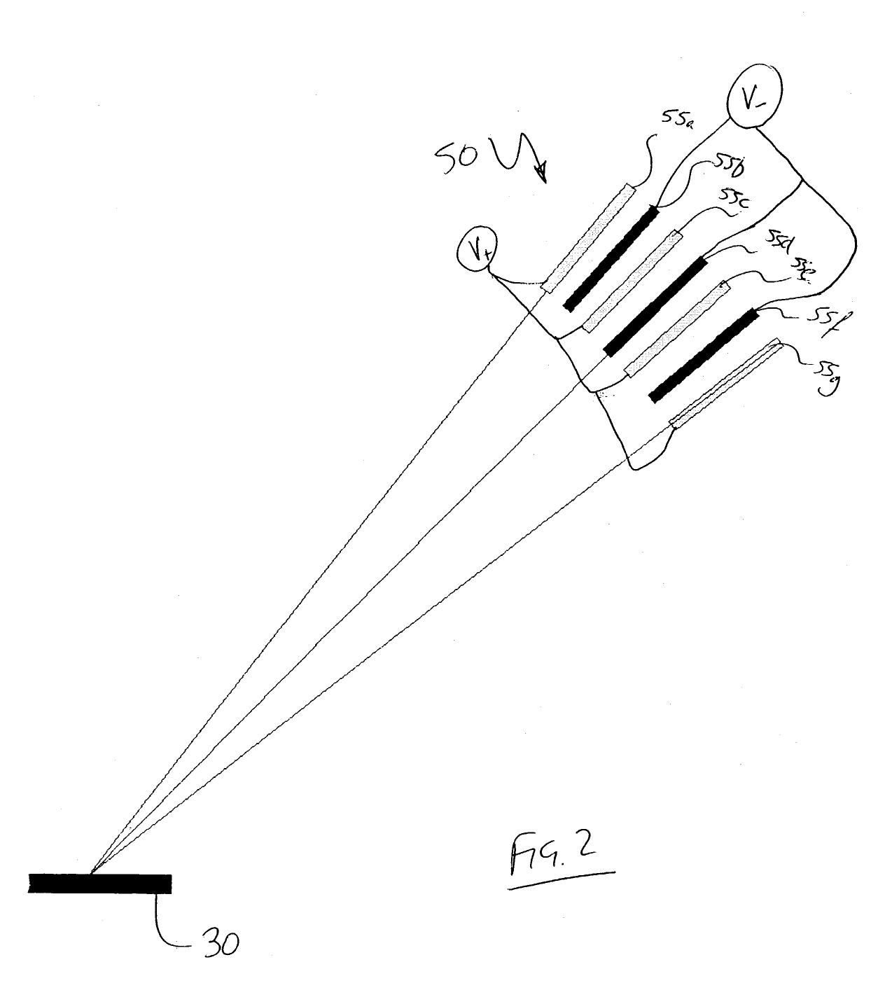

A significant part of the emitted electrons, typically 10° in both the azimuthal and rotational directions, arrive at a gate 50. The gate 50 is capable of opening and closing, electronically, to the passage of the electron beam incident upon it at high speed. The gate 50 is, for most of the time, in the closed position, and opens for a very short period and then shuts again. This allows pulses, typically less than 1 nanosecond in duration, to be passed. The gate 50 is supplied with appropriate current or voltage to generate pulses of a suitable duration and duty cycle, using gate electronics 60. Gate electronics 60 are under the control of a central processor 80 as will be explained in further detail in connection with FIG. 2.

After passing through the gate, the electrons travel in a magnetic-field free flight tube 90, typically of one metre in length, before impinging upon an electron mirror 100. Accurate alignment of the electron optical axis of the system may be achieved by deflectors 110.

The electron mirror 100 acts both to reflect and to focus electrons within the pulse, arriving from the gate 50, on to a detector 120. The detector is of conventional channel plate design, as employed in TOF mass analysers, but optimised for a fast pulse response with a rise time of typically less than 200 picoseconds. Suitable channel plates are manufactured by Burle Electronoptics, Inc. (USA), Hamamatsu Phototonics KK (Japan), and Photonis of France.

Since the electrons in the pulse essentially traverse the flight tube twice, the total flight length is around two metres. Pulses arriving at the detector 120 are amplified by a pre-amplifier 130 and then passed to the histogramming TDC 70.

The central processor 80 controls the gate electronics 60 and the histogramming TDC 70 so as to synchronise each. At the end of the data acquisition period, the histogrammed data is transferred to the central processor 80, which may, for example, be located in a personal computer, for further analysis.

It is to be understood that no input lens is necessary between the sample 30 and the gate 50. Thus, the spectroscopic analyser 10 is capable of operation over a wide range of energies. Nevertheless, when it is desired to acquire data of higher resolution over a narrow range of energies, it is possible to retard the secondary electrons emitted from the sample 30 before they arrive at the gate 50. This may be achieved, for example, by the use of a retarding mesh or lens 140. With this arrangement, the flight tube electron mirror 100 and the detector 120 are elevated to the retarding voltage applied to the retarding mesh or lens 140.

The data acquired allows a measurement of energy to be made. In the absence of retardation of electrons from the sample 30 before they arrive at the gate 50, the energy at which they are emitted remains broadly constant assuming that the vacuum chamber 20 and flight tube 90 are suitably evacuated. Synchronisation of the gate 50 and detector 20 means that the time of flight within the flight tube 90 can be used to calculate the energy of the emitted electron and hence surface analysis can be carried out. Specifically, it may be shown that the time-of-flight, t=d. (m/2E)^{1/2}, where d is the distance between the gate and detector (which is known and is approximately two metres in the present example), m is the (known) mass of the electron and E is the electron energy. This, of course, neglects any relativistic effects. Small corrections from the ideal energy-time flight relationship may be required, to correct for non-ideal behaviour of the mirror 100, but this can be done using digital signal processing, for example, within the central processor 80.

The gate 50 is designed to open or close to the passage of the electron beam under the control of an applied voltage or current from the gate electronics 60. Most simply, the gating may be accomplished by the use of a retarding voltage which is greater than the maximum electron energy. However, it is more favourable to deflect the electrons from their normal flight path towards the gate into a trajectory where they can no longer reach the detector. One particularly preferred way of doing this, which minimises the voltage required to produce the necessary deflection, is shown in FIG. 2.

As seen in FIG. 2, the gate 50 comprises a plurality of plates 55a-55g which are radially disposed from the sample 30. Alternate plates 55a, 55c, 55e and 55g are supplied with a drive voltage of a first polarity (in FIG. 2, this is notionally labelled V+), and the remaining plates 55b, 55d and 55f are supplied with a voltage of the opposing polarity, notionally shown in FIG. 2 as V−. The gate electronics 60 is arranged to supply these opposing polarity voltages.

Alternatively, in order to simplify the electronics 60, the first set of alternate plates 55a, 55c, 55e and 55g may be maintained at a ground potential and the remaining plates 55b, 55d and 55f may be connected to a single drive voltage of either the first or second polarity. In this case, the amplitude of the single drive voltage is approximately 2V (either 2V+ or 2V−).

With these voltages applied, electrons arriving from the sample 30 are deflected either towards baffles located inside the flight tube, towards the inside walls of the flight tube, or towards the deflection plates themselves, such that the electrons are not permitted to arrive at the detector 120 by direct means (including simple reflection in the electron mirror 100). In order to allow the electrons to pass, in a pulse, through the flight tube and on to the detector 120, the voltages V+ and V− (or the single voltage 2V+/−) are momentarily switched off so that the electron beam then passes between the plates 55a-55g without obstruction.

The gate 50 is controlled by the gate electronics 60 and, ultimately, by the central processor 80 to form pulses of a required pulse duration and duty cycle. In the simplest mode of operation, the gate 50 is arranged to generate a single pulse, of typically less than 1 nanosecond duration with a pulse repetition period of typically 100 nanoseconds. The histogrammed data collected at the histogramming TDC 70 then represents the time-of-flight spectrum of the electrons generated from the sample.

More advantageously, however, a pulse sequence is applied to the gate 50 instead of a series of single pulses. The preferred pulse sequence is known as a Hadamard sequence and further details of this may be found, for example, in “The Hadamard Transform” by P Treado and M Morris, Analytical Chemistry (1989) Volume 61, number 11, at pages 72A-734A. The histogrammed TOF signal from the detector 120 is transformed in software to reconstruct the original time-of-flight spectrum using a Hadamard transform, again as described in the above-referenced paper by Treado et al. Such a technique increases the duty cycle of the spectroscopic analyser 10 up to about 50%.

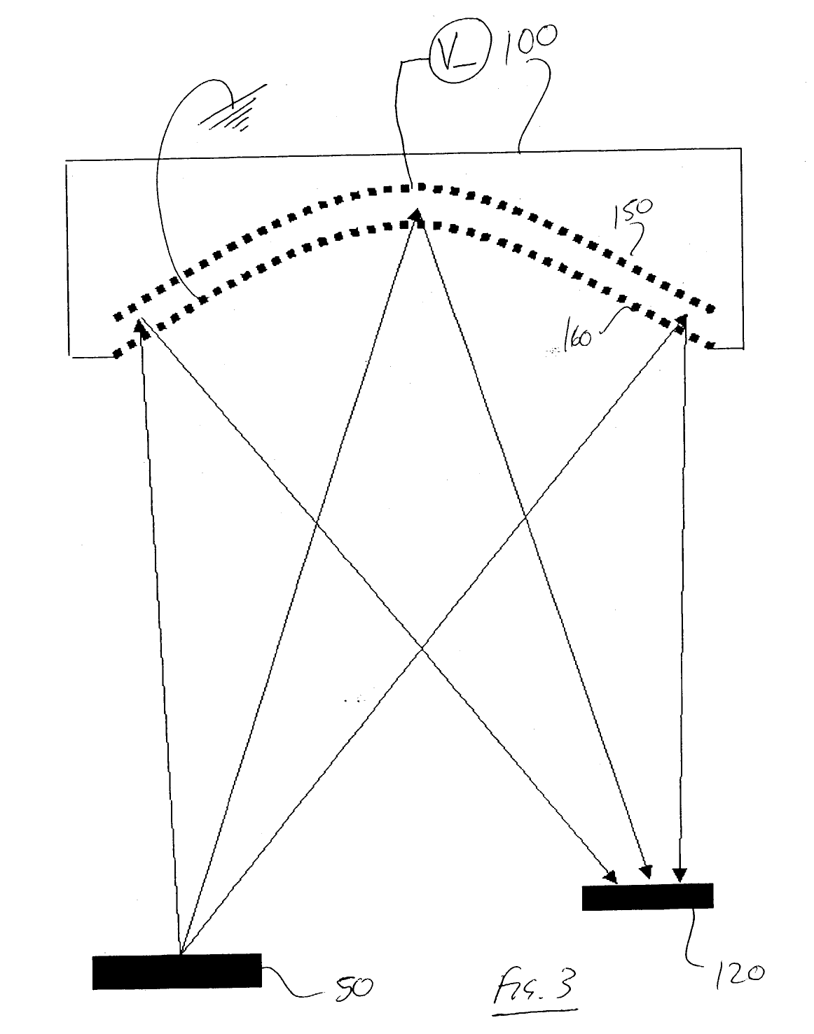

The electron mirror 100 is required both to reflect and focus electrons over a wide energy range, as explained above. However, the mirror does not need to perform energy compensation as it would in an ion beam time-of-flight mass spectrometer. Whilst any suitable electrostatic or magnetic design may be employed (subject to these criteria), a particularly preferred embodiment of an electron mirror 100 is shown in FIG. 3. Here, a pair of concentric meshes 150, 160 are employed. Each mesh has a high transparency. The first mesh (that is, the mesh closest to the gate 50 and detector 120) is held at an earth potential, or alternatively at the potential of the retarding mesh/lens 140 (FIG. 1) if that is employed. The second concentric mesh 150 (that is, the mesh furthest away from the gate 50 and detector 120) is biased to a negative voltage which is slightly larger than the maximum energy of interest.

In order to optimise focussing properties, the meshes are toroidal or elliptical. However, for simplicity, the meshes may alternatively be spherical. An analogous mesh mirror design is used by Artamonov et al, in “An Application of the Electron Mirror in the Time-of-Flight Spectrometer”, Journal of Electron Spectroscopy (2001), Volume 120, pages 11-26.

Whilst specific embodiments have been described, it is to be understood that these are by way of example only and that various modifications are contemplated without departing from the scope of the present invention as claimed. For example, whilst a specific embodiment of a preferred gate 50 has been described and is shown in FIG. 2, other suitable designs may be employed, such as that described in “An Interleaved Comb Ion Deflection Gate for m/z Selection in Time-of-Flight Mass Spectrometry” by Vlasak et al, in Review of Scientific Instruments (January 1996) Volume 67, number 1 at pages 68-72. Likewise, although the invention finds particular use in XPS and Auger electron spectroscopy, it is not necessarily so limited. For example, other forms of spectroscopy which require the determination of the energy of electrons, such as Energy Electron Loss Spectroscopy (EELS), Low Energy Electron Loss Spectroscopy (LEELS), and Ultraviolet Photoelectron Spectroscopy (UPS), may be undertaken with the arrangement set out here.

What is claimed is:

1. A spectroscopic analyser comprising:
means for irradiating a surface of a material to be analysed; and
a time of flight (TOF) spectrometer including:
gating means at an entrance to the TOF spectrometer, the gating means being arranged to receive and selectively pass at least a part of a beam of electrons emitted from the surface of the material to be analysed, as one or more pulses of emitted electrons;
a flight tube along which the or each pulse of emitted electrons is arranged to pass; and
a detector arrangement downstream of the gating means and being arranged to detect the arrival of electrons within the or each pulse from the gating means via the flight tube, and to permit determination of the times of flight of the detected electrons through the flight tube.

2. The spectroscopic analyser of claim 1, further comprising a mirror mounted within the flight tube of the TOF spectrometer and arranged to reflect electrons within the pulse of emitted electrons so that the electrons traverse at least a part of the length of the flight tube in two generally opposing directions.

3. The spectroscopic analyser of claim 2, wherein the mirror is generally spherical.

4. The spectroscopic analyser of claim 2, wherein the mirror is generally toroidal or elliptical.

5. The spectroscopic analyser of claim 2, wherein the mirror comprises first and second transparent concentric meshes spaced along a longitudinal axis of the flight tube.

6. The spectroscopic analyser of claim 5, wherein the first mesh is maintained in use at a first, ground potential, and wherein the second mesh is maintained in use at a second voltage greater than the maximum energy of interest of the electrons in the flight tube.

7. The spectroscopic analyser of claim 1, wherein the gating means comprises a plurality of gating members disposed across the entrance to the flight tube, and defining therebetween a plurality of entrance channels for the emitted electrons, the spectroscopic analyser further comprising means for generating a voltage.

8. The spectroscopic analyser of claim 7, wherein the means for generating a voltage is adapted to generate voltages of opposing polarity, a first output thereof, of a first polarity, being connected in use to even ones of the plurality of gating members, and a second output thereof, of a second polarity, being connected in use to odd ones of the plurality of gating members.

9. The spectroscopic analyser of claim 7, wherein the means for generating a voltage is adapted to generate a voltage of a first polarity which is connected in use to even ones of the plurality of gating members, the odd ones of the said plurality of gating members being maintained in use at a ground potential relative to the said voltage of the first polarity.

10. The spectroscopic analyser of claim 1, further comprising means for retarding the emitted electrons prior to their arrival at the gating means of the TOF spectrometer.

11. The spectroscopic analyser of claim 1, in which the detector arrangement comprises one or more microchannel plates and a time to digital converter (TDC).

12. The spectroscopic analyser of claim 1, in which the means for irradiating the surface of the material is an X-ray generator, arranged to cause emission of secondary electrons from the surface of the material to be analysed via X-ray photoelectron spectroscopy.

13. The spectroscopic analyser of claim 1, wherein the means for irradiating the surface of the material is an electron source arranged to cause emission of secondary electrons from the surface of the material to be analysed via Auger electron spectroscopy.

14. A method of surface analysis spectroscopy comprising:
irradiating a surface of a material to be analysed, so as to cause emission of electrons therefrom;
gating at least a part of the emitted electrons into a flight tube of a time-of-flight spectrometer so as to provide a pulse of electrons therein; and
measuring the time-of-flight of those electrons in the pulse as they pass between the gate and pulse detector.

15. The method of claim 14, further comprising:
reflecting the gated pulse of electrons at an electron mirror within the flight tube.

16. The method of claim 15, the step of reflecting the gated pulse further comprising focussing the gated pulse onto the said pulse detector.

17. The method of claim 14, the step of gating comprising:
applying a voltage and/or a current to a gating means so as selectively to prevent or permit entrance of the said emitted electrons into the flight tube.

18. The method of claim 17, wherein the step of applying a voltage and/or a current comprises applying a voltage to the gating means which is greater than the maximum energy of the emitted electrons, so as to prevent entrance to the flight tube, and applying a second voltage to the gating means which is less than the maximum energy of the emitted electrons so as to permit entrance to the flight tube.

19. The method of claim 14, wherein the step of gating comprises deflecting the emitted electrons between a first direction in which the emitted electrons are directed away from the detector and a second direction in which the emitted electrons are directed toward the detector.

20. The method of claim 17, wherein the gating means comprises a plurality of gating members disposed across an entrance to the flight tube and defining therebetween a plurality of entrance channels for the emitted electrons, the method further comprising:
applying a first voltage to even ones of the plurality of gating members and applying a second voltage to odd ones of the plurality of gating members so as to deflect emitted electrons within the entrance channels and so prevent their entrance into the detector.

21. The method of claim 20, wherein the first voltage is of a first polarity and the second voltage is of a second polarity.

22. The method of claim 20, wherein the first voltage is of a first polarity and the second voltage is a ground potential relative thereto.

23. The method of claim 20, further comprising removing the said applied voltages so as to permit passage of the emitted electrons through the entrance channels, into the flight tube and onwards to the detector.

24. The method of claim 14 comprising gating the emitted electrons as a series of discrete single pulses.

25. The method of claim 14, comprising gating the emitted electrons as at least one sequence of adjacent pulses forming a pulse train.

26. The method of claim 25, in which the sequence of adjacent pulses is a Hadamard sequence.

27. The method of claim 14, further comprising retarding the emitted electrons prior to the step of gating.

28. The method of claim 14, further comprising determining, from the time-of-flight of the electrons pulse(s) as they pass through the flight tube, the energy of the emitted electrons.

29. The method of claim 14, wherein the step of irradiating the material beam surface comprises generating an X-ray incident beam so as to cause emission of secondary electrons from the surface of the material to be analysed via X-ray photoelectron spectroscopy.

30. The method of claim 14, wherein the step pf irradiating the material surface comprises generating a beam of incident electrons, so as to cause emission of secondary electrons via Auger electron spectroscopy.
